(19) United States
(12) Patent Application Publication
(10) Pub. No.: US 2006/0290881 A1
(43) Pub. Date: Dec. 28, 2006

(54) Spectacles set with magnetic clips and detachable magnetic auxiliary frame

(76) Inventor: Siu Yu, Hong Kong (CN)

Correspondence Address: Raymond Y. Chan, Suite 128, 108 N. Ynez, Monterey Park, CA, 91754, US

(21) Appl. No.: 11/406,659

(22) Filed: Apr. 18, 2006

Related U.S. Application Data
(60) Provisional application No. 60/693,635, filed on Jun. 25, 2005.
(60) Provisional application No. 60/722,515, filed on Sep. 30, 2005.

(51) Int. Cl. G02C 5/00

(52) U.S. Cl. 351/41

(57) ABSTRACT

A spectacles set includes a primary spectacles and a magnetic auxiliary frame. The magnetic auxiliary frame includes two auxiliary lenses, an auxiliary frame body, and a magnetic mounting arrangement including at least one magnetic holder and at least one supporting arm. The magnetic holders are spacedly mounted at the auxiliary frame, wherein each of the magnetic holders includes a frame holder detachably mounted to the primary spectacles frame of the primary spectacles, and a magnetic seat supported by the frame holder. The supporting arms are rearwardly or frontwardly and spacedly extended from the magnetic auxiliary frame to substantially align with the magnetic seats respectively, wherein each of the supporting arms comprises a magnetic member magnetically attract with the respective magnetic seat to detachably mount the magnetic auxiliary frame in front or back of the primary spectacles frame.

### CROSS REFERENCE OF RELATED APPLICATION

This is a non-provisional application for a provisional application having an application Ser. No. of 60/693,635, and a filing date of Jun. 25, 2005.

### BACKGROUND OF THE PRESENT INVENTION

1. Field of Invention

The present invention relates to a spectacles frame, and more particularly to a spectacles set which comprises one or more magnetic clips adapted for locking on the primary spectacles frame and a detachable auxiliary frame constructed for attaching with the magnetic clips by means of magnetic attraction force. Thus, the auxiliary frame can be mounted in front or at the back of the primary spectacles.

2. Description of Related Arts

Auxiliary frames are widely used today. A conventional spectacles set comprising a magnetic auxiliary frame is popular. The advantage of the spectacles set is that it is very convenient to attach or detach the detachable auxiliary frame on or from the primary spectacles. But it still has shortcoming. Users have to choose a primary spectacles frame having magnetic engaging member to match with the magnetic auxiliary frame they like. Thus, usage of auxiliary frame is limited greatly. Moreover, some spectacles sets having magnet embedded on the primary spectacles frame generate magnetic fields. If users wear the primary spectacles frame very often, he or she will be interfered by the magnetic field. So such shortcoming further limits the market.

### SUMMARY OF THE PRESENT INVENTION

The present invention provides a spectacles set which includes a primary spectacles frame, one or more clips adapted for locking on primary spectacles frame and a detachable auxiliary frame adapted for attaching with clips so as to mount in front of or at the back of the primary spectacles frame. Magnetic clips can be mounted on any styles of primary spectacles frames, and can also adjust the length of parts of the primary spectacles frame. So the spectacles set is not only sold in set but also can be sold apart so as to accomplish dealer's lower investment and broader market.

A main object of the present invention is to provide a spectacles set which comprises a non-magnetic primary spectacles frame and one or more magnetic clips mounted on the primary spectacles frame and a detachable auxiliary frame constructed for attaching with clips by means of magnetic attraction so as to mount the auxiliary frame in front or at the back of the primary spectacles frame.

Another object of the present invention is to provide a spectacles set, wherein the locking units are set on magnetic clips, securely locking magnetic clips on the primary spectacles frame. When not in use, magnetic clips can be detached easily.

Another object of the present invention is to provide a spectacles set, wherein the magnetic clips have locking unit, meanwhile the primary spectacles frame has a locking arrangement extended from parts of the primary spectacles frame, such as nose supports, primary bridge, side extensions, frame body or temples. Locking unit has one or more convex engaging members or engaging recesses or engaging loops, correspondingly locking arrangement has one or more engaging members protruded or recessed or looped, in such a manner magnetic clips securely interlock with the primary spectacles frame, meantime adjusting the length of the parts of the primary spectacles frame, such as primary bridge, side extensions or temples.

Another object of the present invention is to provide a spectacles set, wherein the magnetic clips are self-locked on the primary spectacles frame by using of locking unit, which has one or more convex engaging members on one edge of clip and one or more corresponding engaging recesses or engaging loops on the other edge, convex engaging member is received in engaging recess or engaging loop respectively when clip self-locks on the primary spectacles frame. Therefore, no locking arrangements are required for the primary spectacles frame.

Another object of the present invention is to provide a spectacles set, wherein the magnetic clip is made of non-magnetic material and a magnet is mounted in the magnetic holder. Magnetic clip attaches different part of the primary spectacles frame, accordingly magnetic holder extend from different part of the magnetic clip, so as to magnetically attract to the auxiliary frame effectively.

Another object of the present invention is to provide a spectacles set, wherein the magnetic auxiliary frame has a supporting arms, wherein a magnet is mounted in the magnetic housing. Magnetic housing of the auxiliary frame magnetically attract magnetic holder of the magnetic clip mounted on the primary spectacles frame, thus auxiliary frame is further mounted in front of or at the back of the primary spectacles frame in position. If there is magnet mounted on magnetic clip, magnetic auxiliary frame including supporting arms can be made of a kind of metal having magnetic attraction ability such as mild steel, low carbon steel and high grade steel, which is attractive to magnetic material such as permanent magnet, no need of magnet mounted on auxiliary frame, so as to expand the attraction scope.

Accordingly, through the above objects carried out, the present invention accomplishes a general object: the spectacles set can be sold in set, also can be sold apart. So the optical dealer will buy and sell spectacles sets more freely with lower investment and broader market. The accomplishment of the goal also benefits the users. User can choose a primary spectacles frame and an auxiliary frame as he or she likes, then match proper magnetic clips. A perfect spectacles set is finished. When wearer do not wear auxiliary frame, magnetic clips can be detached from the primary spectacles frame. Due to magnetic attraction magnetic clips attach magnetic auxiliary frame, which can be put together in case for keeping.

In other words, the present invention provides, in its broadest sense, a spectacles set, comprising:

a primary spectacles comprising two lenses and a primary frame for holding the lenses in position, wherein the primary frame comprises a primary bridge extended between two inner sides of the lenses respectively and two side extensions extended from two outer sides of the lenses respectively; and

a magnetic auxiliary frame, which comprises:

a two auxiliary lenses;

an auxiliary frame body for holding the auxiliary lenses in position, wherein the magnetic auxiliary frame comprises an auxiliary bridge extended between two inner sides of the two auxiliary lenses respectively; and

a magnetic mounting arrangement which comprises:

at least one magnetic holder spacedly mounted at the auxiliary frame, wherein the magnetic holder comprises a frame holder detachably mounted to the primary frame of the primary spectacles and a magnetic seat supported by the frame holder; and

at least one supporting arm spacedly extended from the auxiliary frame to substantially align with the magnetic seats respectively, wherein each of the supporting arms comprises a magnetic member magnetically attract with the respective magnetic seat to detachably mount the magnetic auxiliary frame on the primary spectacles frame.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a primary spectacles according to a preferred embodiment of the present invention.

FIG. 2 is a schematic view of a locking arrangement extended from the primary bridge of the primary spectacles frame according to the present invention.

FIG. 3 is a schematic view of a locking arrangements extended from two side extensions of the primary spectacles frame according to the present invention.

FIG. 4 is a schematic view of a locking arrangement extended from frame body of the primary spectacles frame according to the present invention.

FIG. 5 is a first alternative mode of a locking unit of the magnetic clips according to the present invention.

FIG. 6 illustrates a second alternative mode of a locking unit of the magnetic clips according to the present invention.

FIG. 7 illustrates a third alternative mode of a locking unit of the magnetic clips according to the present invention.

FIG. 8 illustrates a forth alternative mode of a locking unit of the magnetic clips according to the present invention.

FIG. 9 is a partially perspective view of the convex engaging member and engage recess of the magnetic clips according to the present invention.

FIG. 10 is a partially perspective view of the convex engaging member and engage loop of the magnetic clips according to the present invention.

FIG. 11 is a partially perspective view of a magnetic auxiliary frame according to the present invention.

FIG. 12 is a first alternative mode of a supporting arm of the magnetic auxiliary frame according to the present invention.

FIG. 13 is a second alternative mode of a supporting arm of the magnetic auxiliary frame according to the present invention.

FIG. 14 is a partially perspective view of a magnetic clip illustrating the magnetic clip being self-locked on the primary spectacles frame according to the present invention.

FIG. 15 is a partially perspective view of a magnetic clip illustrating the elongated magnetic clip being interlocked with the primary spectacles frame according to the present invention.

FIG. 16 is a perspective view of a spectacles set illustrating magnetic clip being mounted on the primary spectacles frame, auxiliary frame being magnetically attached on the primary spectacles frame according to the above preferred embodiment of the present invention.

FIG. 17 is a partially perspective view of a spectacles set illustrating magnetic clip being mounted on the primary spectacles frame, auxiliary frame being magnetically attached on the primary spectacles frame according to the above preferred embodiment of the present invention.

FIG. 18 is another partially perspective view of a spectacles set illustrating magnetic clip being mounted on the primary spectacles frame, auxiliary frame being magnetically attached on the primary spectacles frame according to the above preferred embodiment of the present invention.

FIG. 19 is a perspective view of a rimless primary spectacles frame according to the present invention.

FIG. 20 is a perspective view of a rimless auxiliary frame according to the present invention.

FIG. 21 is a perspective view of the magnetic mounting arrangement according to the above preferred embodiment of the present invention.

FIG. 22 is an exploded perspective view of the magnetic mounting arrangement according to the above preferred embodiment of the present invention

FIG. 23 is a sectional side view of the magnetic mounting arrangement according to the above preferred embodiment of the present invention.

FIG. 24 is an alternative mode of the spectacles set according to the above preferred embodiment of the present invention.

FIG. 25 is a second alternative mode of the spectacles set according to the above preferred embodiment of the present invention.

FIG. 26A and FIG. 26B are schematic diagrams of a third alternative mode of the spectacles set according to the above preferred embodiment of the present invention.

FIG. 27 is a forth alternative mode of the spectacles set according to the above preferred embodiment of the present invention.

### DETAILED DESCRIPTION OF THE PREFERRED EMBODIMENT

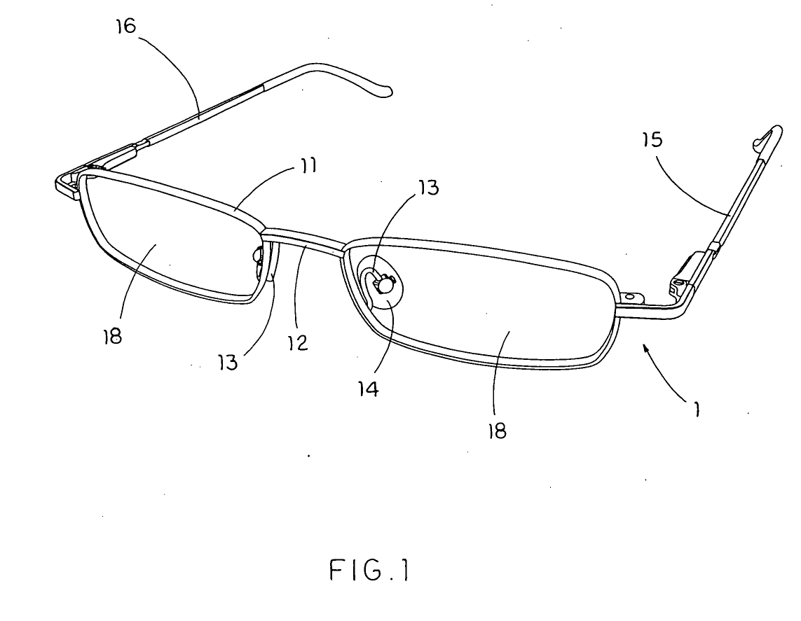

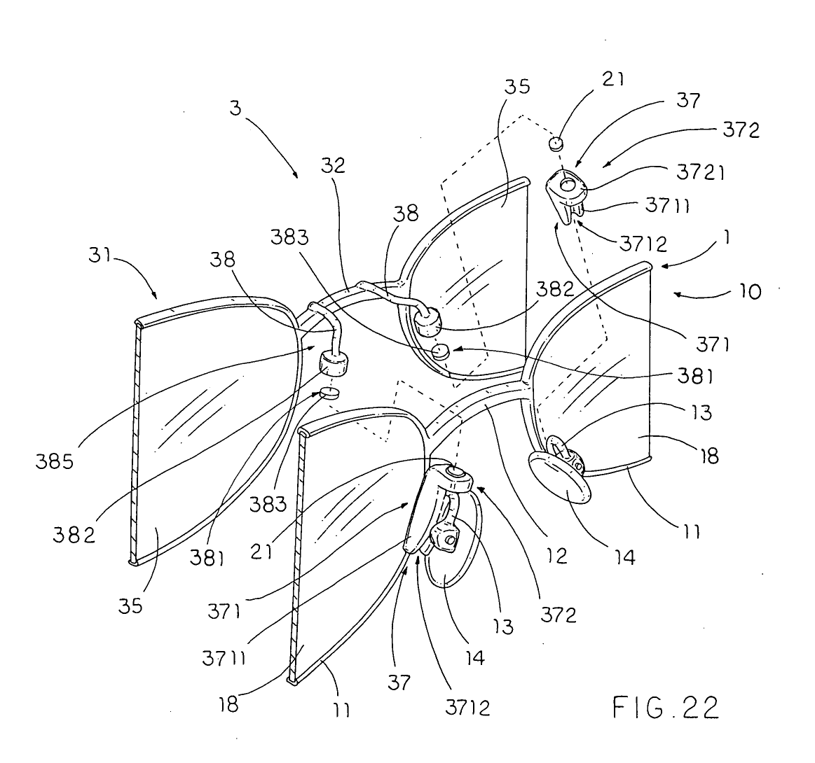

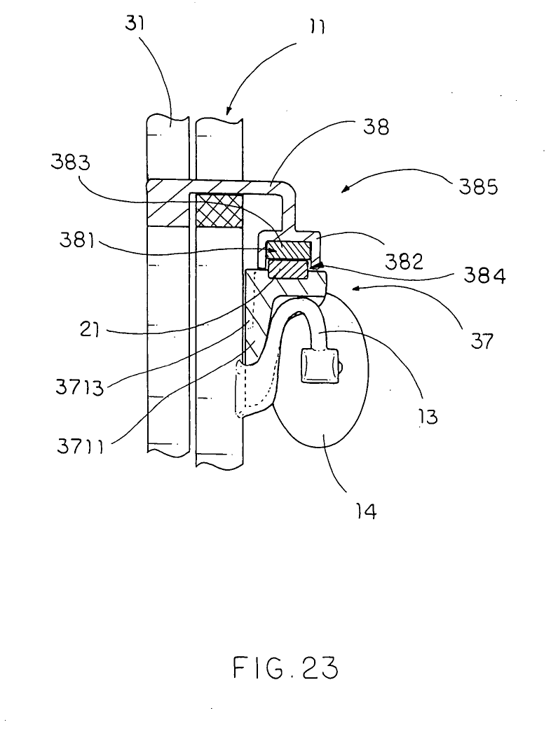

Referring to FIG. 1 to FIG. 23 of the drawings, a spectacles set according to a preferred embodiment of the present invention is illustrated, in which the spectacles set comprises a primary spectacles 10 and a detachable magnetic auxiliary frame 3.

The primary spectacles 10 comprises two lenses 18, and a primary spectacles frame 1 for holding the lenses 18 in position, wherein the primary spectacles frame 1 comprises a primary bridge 12 extended between two inner sides of the lenses 18 respectively, and two side extensions 15, 16 extended from two outer sides of the lenses 18 respectively.

In other words, as shown in FIG. 1 of the drawings, the primary spectacles frame 1 comprises a frame body 11 for mounting the pair of lenses 18 in position. The frame body 11 comprises the primary bridge 12 connected between the two lenses 18 respectively, two nose supports 13 attached and extended at two inner sides of the lenses 18 respectively, two nose pads 14 extended from two nose supports 13 respectively, and the side extensions 15,16 for coupling with a pair of temples 17 respectively.

The magnetic auxiliary frame 3 comprises two auxiliary lenses 35, an auxiliary frame body 31, and a magnetic mounting arrangement. The auxiliary frame body 31 is for holding the auxiliary lenses 35 in position, wherein the auxiliary frame body 31 comprises an auxiliary bridge 32 extended between two inner sides of the two auxiliary lenses 35 respectively.

The mounting arrangement comprises a magnetic unit 385 rearwardly extended from the auxiliary frame body 31, and a magnetic adapter selectively and detachably mounted at the primary spectacles frame 1 to align with the magnetic unit 385, wherein the magnetic unit 385 is magnetically attracted with the magnetic adapter to detachably mount the magnetic auxiliary frame 3 in front of the primary spectacles frame 1.

The magnetic unit 385 comprises two magnetic members 381 spacedly extended from the auxiliary frame body 31, wherein the magnetic adapter comprises two magnetic holders 37 spacedly and detachably mounted at the primary spectacles frame 1 to align with the two magnetic members 381 respectively, such that when the magnetic members 381 are magnetically attracted with the magnetic holders 37 respectively, the magnetic auxiliary frame 3 is detachably mounted in front of the primary spectacles frame 1.

Each of the magnetic holders 37 comprises a frame holder 371 detachably mounted to the primary spectacles frame 1 and a magnetic seat 372 which comprises a magnetic housing 3721 supported by the frame holder 371 and a first magnetic element received in the magnetic housing 3721, wherein the magnetic members 381 are magnetically mounted to the first magnetic elements respectively to retain the magnetic auxiliary frame 3 in front of the primary spectacles frame 1.

According to the preferred embodiment of the present invention, the two frame holders 371 are two clipping members detachably clipping at two nose supports 13 of the primary spectacles frame 1 to support the magnetic seats 372 so as to magnetically attract the magnetic members 381 respectively.

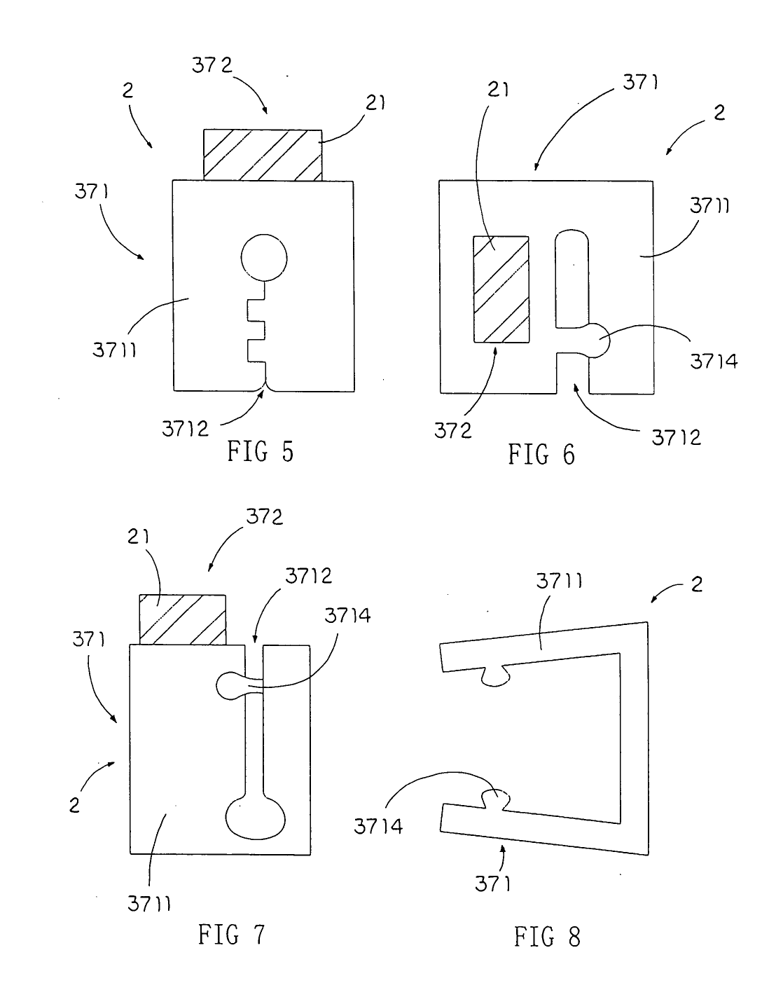

In other words, referring to FIG. 1 to FIG. 20 of the drawings, a spectacles set of the present invention is illustrated, wherein the spectacles set comprises a primary spectacles frame 1 and one or more magnetic clips 2 and a detachable magnetic auxiliary frame 3. According to the preferred embodiment, the magnetic holders 37 are specifically embodied as the magnetic clips 2 respectively. Moreover as shown in FIG. 5 of the drawings, the magnetic clip 2 comprises a magnet 21 and a locking unit at both edges.

The magnetic unit 385 further comprises the two supporting arms 38 rearwardly extended from the auxiliary frame body 31 to align with the magnetic holders 37 respectively, wherein the two magnetic members 381 are downwardly extended from rear ends of the supporting arms 38 to magnetically mount on the magnetic holders 37 respectively.

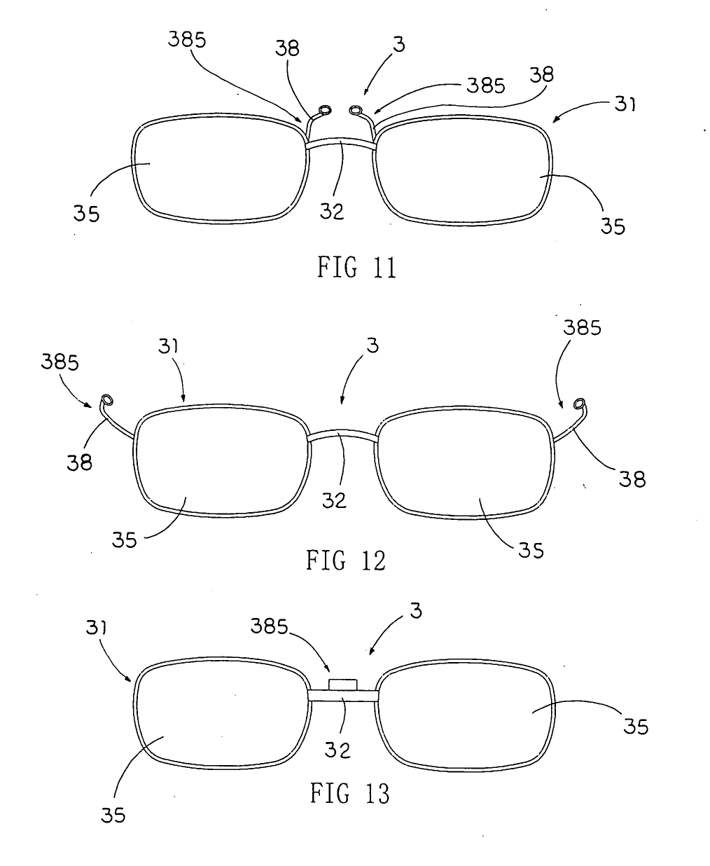

As shown in FIG. 11 of the drawings, the magnetic auxiliary frame 3 comprises the auxiliary frame body 31 for supporting the two auxiliary lenses 35, the auxiliary bridge 32 extended between the two auxiliary lenses 35, the two supporting arms 38 extended from the inner side of two auxiliary lenses 35 respectively and magnet pieces embodied as the magnetic members 381 supported at the supporting arms 38 respectively.

The two supporting arms 38 are rearwardly and spacedly extended from the auxiliary bridge 32 to ride across the primary bridge 12 so as to magnetically mount to the magnetic holders 37 respectively.

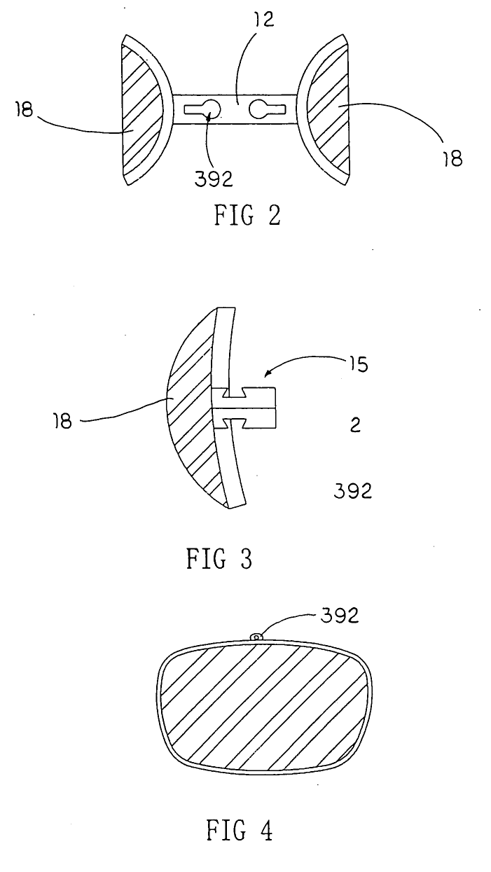

As shown in FIG. 2, FIG. 3, FIG. 4 and FIG. 15 of the drawings, the locking arrangement of the primary spectacles frame 1 extended from primary bridge 12, side extensions 15, frame body 11. Locking arrangement of the primary spectacles frame 1 interlocks with locking unit of the magnetic clip 2, so securely hold magnetic clip 2 on the primary spectacles frame 1. As shown in FIG. 15 of the drawings, the locking arrangement of the primary spectacles frame 1 interlocks with locking unit of the magnetic clip 2, meanwhile adjusting the length of primary bridge 12 of the primary spectacles frame 1 and temples 17 of the primary spectacles frame 1.

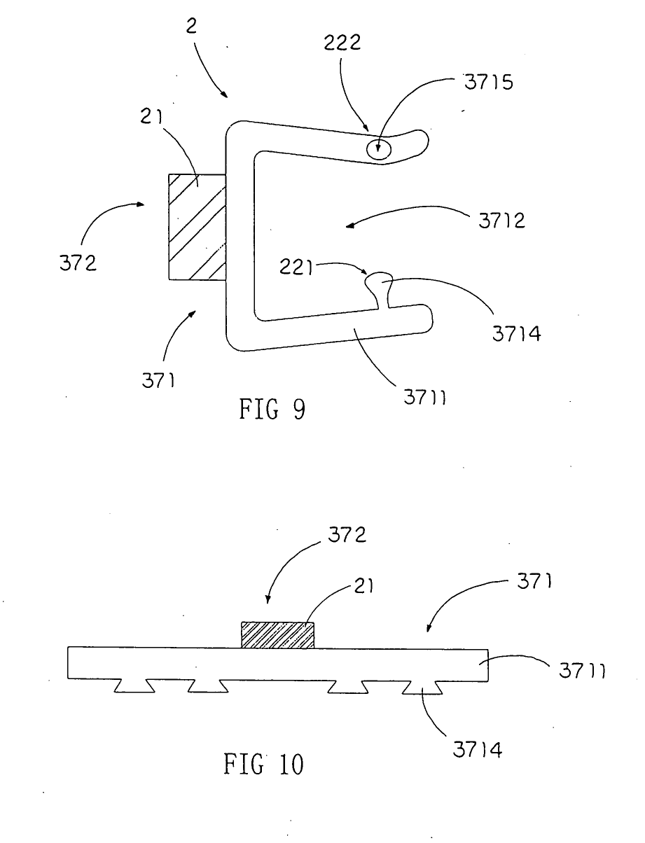

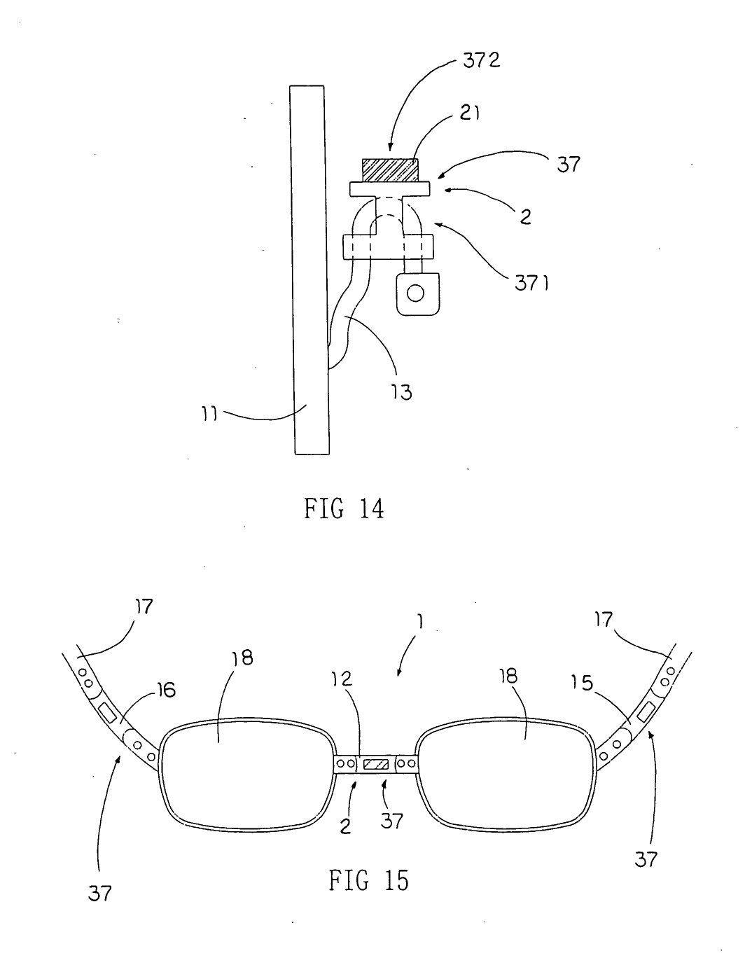

As shown in FIG. 5, FIG. 6, FIG. 7, FIG. 8, FIG. 9, FIG. 10, and FIG. 14 of the drawings, the magnetic clip 2 has locking unit, the shape of locking unit can vary differently to match the parts of primary spectacles frame 1 respectively, but the attributes and function of the locking unit is unchanged: securely mounting magnetic clip 2 on the primary spectacles frame 1 resorting to the power when two edges of magnetic clip 2 close.

As shown in FIG. 9 of the drawings, the locking unit of the magnetic clip 2 has convex engaging member 221 at one edge and engaging recess 222 at the other edge.

As shown in FIG. 9 to FIG. 10 of the drawings, the locking unit of the magnetic clip 2 has convex engaging member 221 at one edge and engaging loop at the other edge. Referring to FIG. 5, FIG. 6, FIG. 7 and FIG. 14 of the drawings, the locking unit of the magnetic clip 2 self-lock magnetic clip 2 on the primary spectacles frame 1, and no locking arrangement is required on the primary spectacles frame 1. As shown in FIG. 8 locking unit interlocks with locking arrangement of the primary spectacles frame 1. Convex engaging members 221 on both edges of magnetic clip 2 engage with corresponding engaging members—recess of the primary spectacles frame 1.

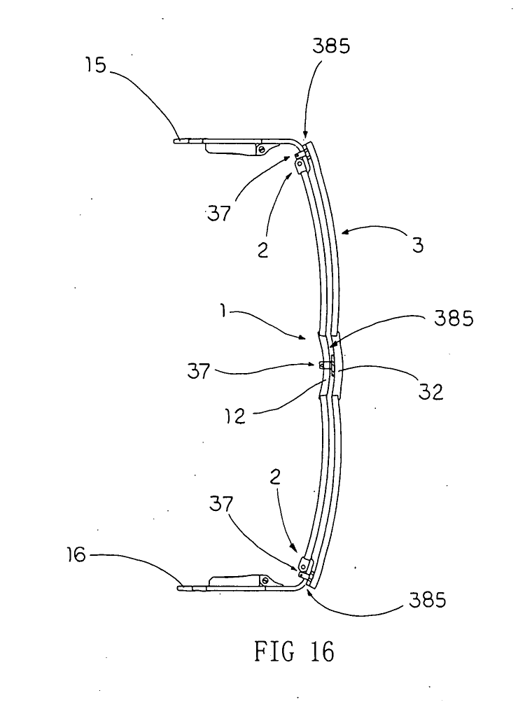

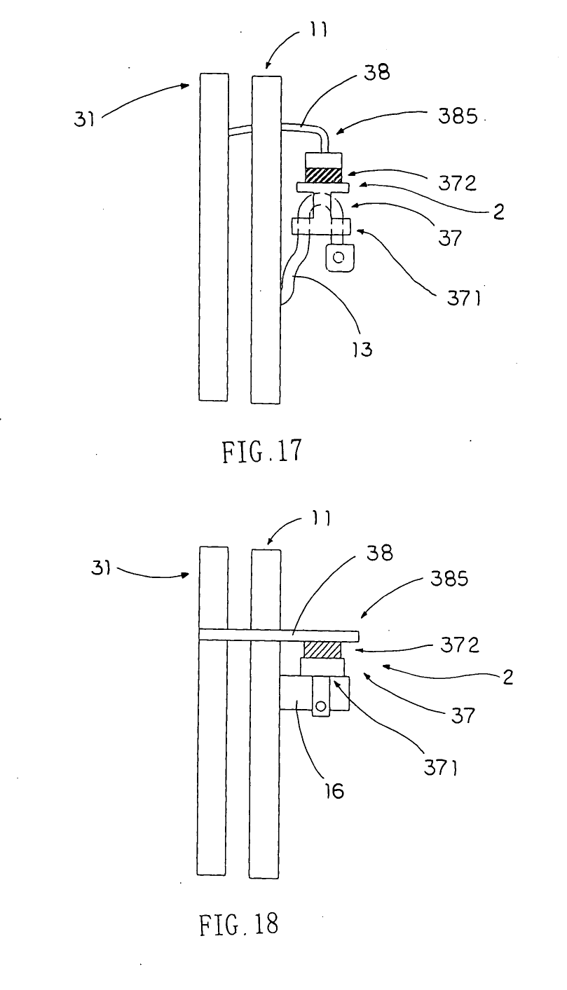

As shown in FIG. 11, FIG. 12, and FIG. 13 of the drawings, the supporting arms 38 of the magnetic auxiliary frame 3 can extend from different part of the auxiliary frame 3. Accordingly magnetic clips 2 will be mounted on different parts of the primary spectacles frame 1. Referring to FIG. 11 of the drawings, the supporting arms 38 extend from the inner side of the auxiliary frame body 31, referring to FIG. 12 of the drawings, the supporting arms 38 extends from the outer side of the auxiliary frame body 31. Referring to FIG. 13 of the drawings, the supporting arms 38 are extended from the auxiliary bridge 32 of the magnetic auxiliary frame 3. As shown in FIG. 16, FIG. 17, and FIG. 18 of the drawings, a user can choose a primary spectacles frame 1 and a detachable magnetic auxiliary frame 3 as he or she likes, then mount proper magnetic clips 2 on the primary spectacles frame 1, thereafter close the magnetic auxiliary frame 3 to the primary spectacles frame 1, due to magnetic attraction between the magnetic clips 2 and magnetic auxiliary frame 3, magnetic auxiliary frame 3 will be quickly held on the primary spectacles frame 1 in position. As shown in FIG. 17 of the drawings, the magnetic clips 2 are mounted on the nose supports 13 of the primary spectacles frame 1. As shown in FIG. 18 of the drawings, the magnetic clips 2 are mounted on the two side extensions 16 of the primary spectacles frame 1.

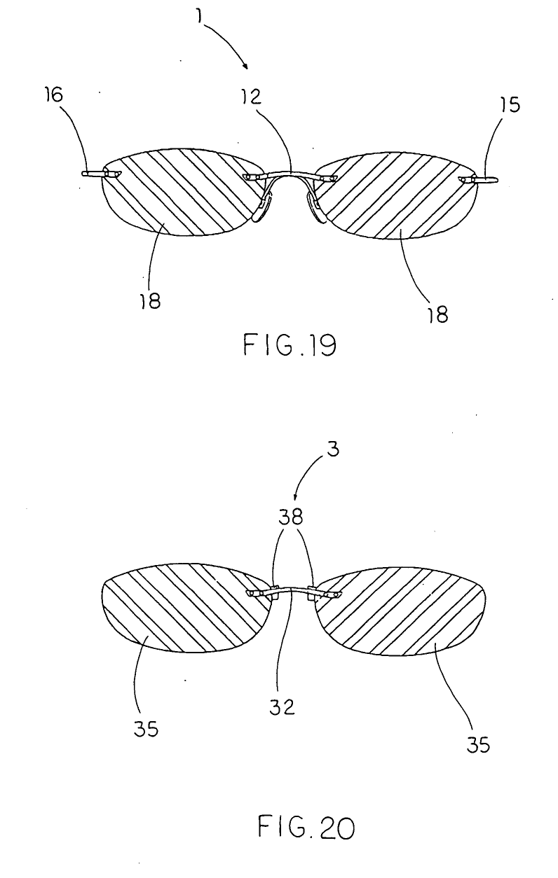

As shown in FIG. 19 of the drawings, two ends of the primary bridge 12 and side extensions 15, 16 are directly fastened to edges of two lenses 18 respectively so as to form primary spectacles frame 1 as a rimless spectacles frame.

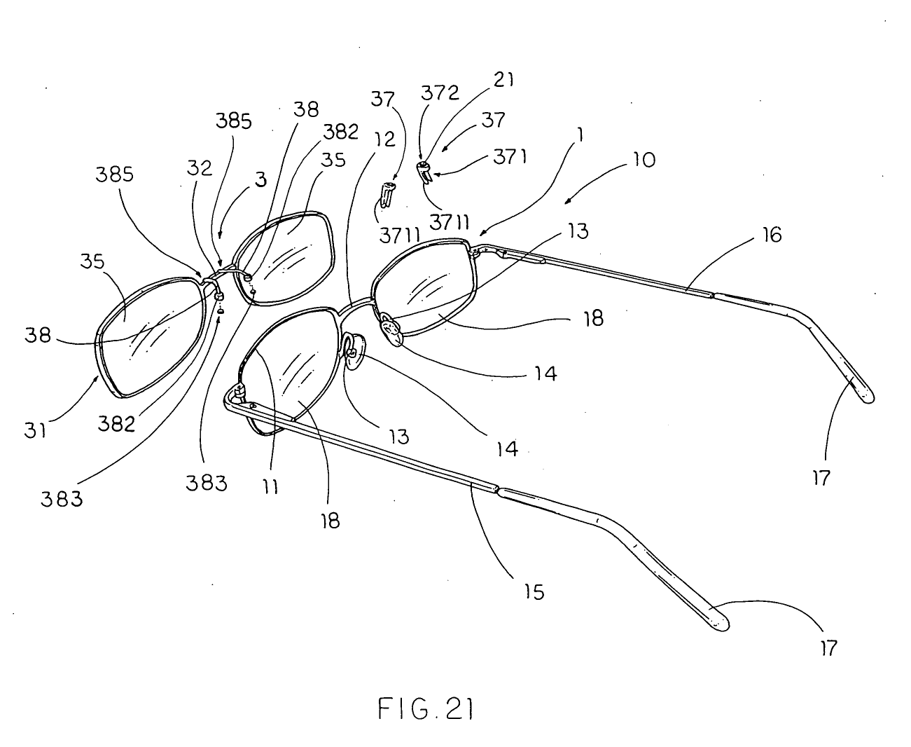

As shown in FIG. 20 of the drawings, two ends of the auxiliary bridge 32 are directly fastened to edges of two auxiliary lenses 35 respectively so as to form the magnetic auxiliary frame 3 as a rimless auxiliary frame.

In other words, referring to FIG. 21 and FIG. 23 of the drawings, according to the preferred embodiment of the present invention, the frame holder 371 of each of the magnetic adapters is elongated in shape and comprises two clipping members 3711 downwardly and spacedly extended from the magnetic seat 372 in a elastic manner to define a clipping groove 3712 between the clipping members 3711, wherein the clipping members 3711 are adapted to detachably attach on the respective nose support 13 of the primary spectacles frame 1.

More specifically, each of the nose supports 13 is rearwardly extended from the primary spectacles frame 1 at the respective inner side of the respective lens 18 to form a U-shaped cross section, wherein the nose support 13 is adapted to be detachably received into the clipping groove 3712 for detachably attaching the magnetic adapters 37 onto the primary spectacles frame 1.

Moreover, each of the magnetic holders 37 further comprises a magnetic element which is preferably embodied as the magnet 21 mounted on top of the magnetic seat 372 for creating magnetic attraction force between the primary spectacles 1 and the magnetic auxiliary frame 3. The magnetic seats 372 are integrally formed on top of the frame holders 371 respectively wherein the magnetic elements are provided on the magnetic seats 372 respectively for aligning with the magnetic units 385 respectively.

It is worth mentioning that each of the magnetic holders 37 are detachably and alignedly affixed on the respective nose supports 13 which is downwardly inclined from a mid portion of the primary bridge 12 so that the magnetic adapters 37 are likewise downwardly inclined according to the nose supports 13 respectively.

Moreover, each of the frame holders 371 further has a rear sidewall 3713 downwardly and integrally extended between the clipping members 3711 to form as a rear sidewall 3713 of the clipping groove 3712 in such a manner that a depth of the rear sidewall 3713 is smaller than a depth of the clipping members 3711 so as to restrict unwanted frontward movement of the frame holder 371 when it is detachably affixed on the primary spectacles frame 1. It is worth mentioning that because the depth of the rear sidewall 3713 is slightly smaller than that of the clipping members 3711, the clipping members 3711 is retained their elasticity to detachably attach on the primary spectacles frame 1 in a secure manner while the rear sidewall 3713 restricts unwanted frontward movement of the respective magnetic holder 37.

In addition, the magnetic seat 372 of the magnetic adapters 37 is extended on top of the clipping groove 3712, wherein a bottom surface of the magnetic seat 372 is adapted to bias against the respective nose support 13 when it is received in the clipping groove 3712. Therefore, the magnetic seat 372 not only provides a platform for mounting the magnetic element thereon, but is also positioned to restrict unwanted downward movement of the magnetic holder 37 by biasing against the respective nose support 13.

Each of the magnetic units 385 further comprises a magnetic casing 382 formed at a rear end portion of the respective supporting arm 38, wherein the magnetic member 381 is securely received in the magnetic casing 382 for magnetically attaching on the magnetic element of the respective magnetic holder 37.

On the other hand, each of the magnetic members 381 comprises a second magnetic element 383 received in the magnetic casing 382 to form an engaging groove 384 within the magnetic casing 382, wherein a thickness of the first magnetic element is larger than a depth of the magnetic housing 3721 to form an engaging member arranged in such a manner that when the magnetic members 381 are magnetically mounted on the magnetic seats 372 respectively, the engaging members are received in the engaging grooves 384 respectively so as to ensure the auxiliary frame body 31 mounting in front of the primary spectacles frame 1.

It is then worth mentioning that for each of the magnetic units 385, a depth of the magnetic member 381 is slightly smaller than a depth of the magnetic casing 382 to so as to define the engaging groove 384 between a bottom side of the magnetic member 381 and an outer edge of the magnetic casing 382, wherein the magnetic element of the corresponding magnetic holder 37 is arranged to be detachably received into the engaging groove 384 for magnetically attaching with the magnetic member 381 in a stable manner.

The operation of the present invention is as follows: when the user desires to put on the magnetic auxiliary frame 3, he/she simply needs to attach the magnetic adapters onto the primary spectacles frame 1. After that, the user simply needs to attach the magnetic auxiliary frame 3 on the primary spectacles 10 by magnetically attaching the magnetic adapters with the magnetic units 385 respectively in the above-mentioned fashion. In other words, when the user desires to take off the magnetic auxiliary frame 3, he/she can simply detach the magnetic auxiliary frame 3 and the magnetic adapters from the primary spectacles frame 1. The primary spectacles 10 will then function as a regular spectacles. Thus, the manufacturing cost of the present invention can be minimized and that the magnetic auxiliary frame 3 fits for a wide variety of spectacles.

It is worth mentioning that a slight variation of the above-mentioned preferred embodiment may nevertheless be anticipated. For example, the magnetic adapter is detachably mounted at the primary spectacles frame 1 at a position between the two inner sides of the lenses 18, wherein the magnetic unit 385 is rearwardly extended from the magnetic auxiliary frame 3 to alignedly and magnetically attract to the magnetic adapter so as to detachably mount the auxiliary frame body 31 in front of the primary spectacles frame 1.

As a result, the magnetic adapter is detachably mounted at the primary bridge 12 of the primary spectacles frame 1, wherein the magnetic unit 385 is rearwardly extended from the magnetic auxiliary frame 3 to ride across the primary bridge 12 to alignedly and magnetically attract to the magnetic adapter so as to detachably mount the auxiliary frame body 31 in front of the primary spectacles frame 1.

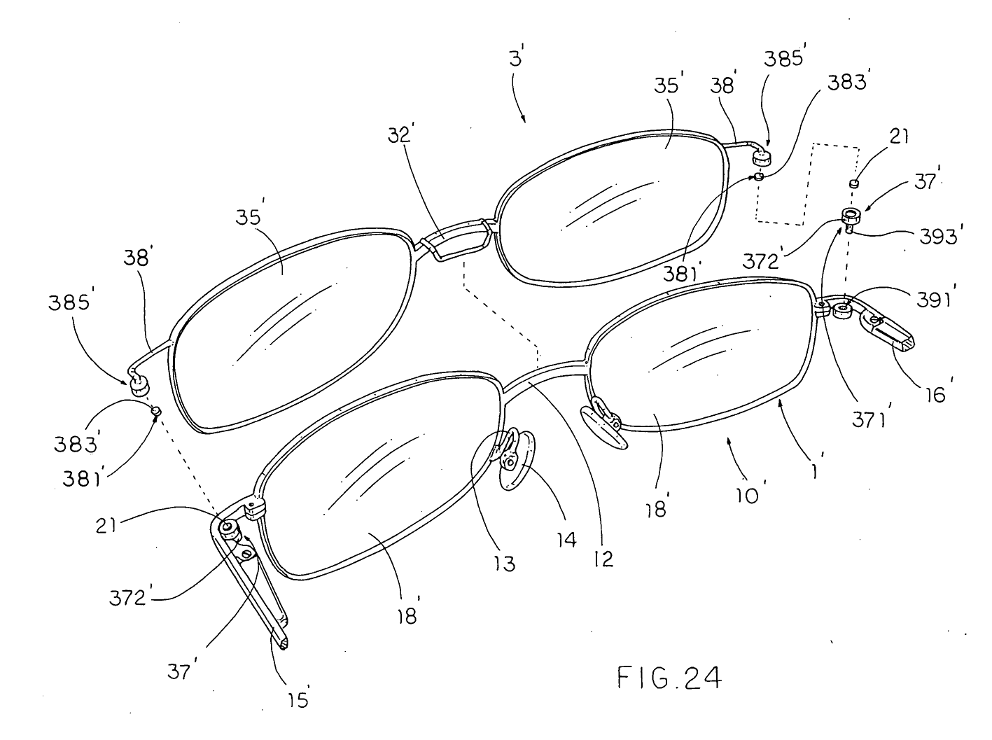

Referring to FIG. 24 of the drawings, an alternative mode of the spectacles set according to the preferred embodiment of the present invention is illustrated. The alternative mode is similar to the preferred embodiment except the magnetic mounting arrangement. According to the alternative mode, each of the magnetic holders 37′ has a retention slot 391′ formed at the rear side of each of the side extensions 15′, 16′ of the primary spectacles frame 1′ and comprises an inserting member 393′ which supports the respective magnetic seat 372′ thereon and detachably inserts into the retention slot 391′ to magnetically attract the respective magnetic member 381′ (i.e. the second magnetic element 383′).

Accordingly, the frame holders 371′ are shaped and crafted to fittedly insert into the retention slots 391′ whereas the magnetic seats 372′ are provided on the frame holders 371′ to substantially align with the magnetic units 385′ respectively. In other words, a diameter of each of the inserting members 393′ is smaller than a diameter of the retention slot 391′ so that the frame holder 371′ is capable of fittedly inserting into the retention slot 391′ for detachably mounting on the primary spectacles frame 1′.

On the other hand, the magnetic units 385′ are rearwardly extended from two outside sides of the auxiliary lenses 35′ at the magnetic auxiliary frame 3′ to magnetically attach on the magnetic seat 372′ supported at the retention slots 391′ respectively, so as to magnetically attach the magnetic auxiliary frame 3′ in front of the primary spectacles 10′.

As a result, the two supporting arms 38′ are rearwardly extended from two outer sides of the auxiliary lenses 35′ of the magnetic auxiliary frame 3′ to ride across the side extensions 15′, 16′ so as to magnetically mount on to the magnetic holders 37′ respectively.

A brief description of the various alternatives of the magnetic holders 37 is elaborated as follows: referring to FIG. 2, FIG. 3 and FIG. 4 of the drawings, the primary bridge 12, side extensions 15, 16 and frame body 11 may have a plurality of attaching slots 392 formed thereon while the magnetic adapters are securely engaged with the attaching slots 392.

Referring to FIG. 5 of the drawings, the clipping members 3711 of each of the frame holders 371 is embodied as having a teeth portion as a sidewall of the clipping groove 3712, wherein the magnetic adapters are adapted to engage with the primary spectacles frame 1. Referring to FIG. 6 to FIG. 7 of the drawings, the clipping groove 3712 may be an elongated groove having the two clipping members 3711 as sidewalls respectively.

Referring FIG. 5 to FIG. 8 of the drawings, each of the magnetic adapters is adapted to detachably attach on the primary bridge 12 for magnetically attaching with the magnetic units 385, wherein each of the clipping members 3711 further has an engaging tip 3714 which is adapted to engage with the primary spectacles frame 1 for ensuring secure engagement between the magnetic holder 37 and the primary spectacles frame 1.

Referring to FIG. 9 of the drawings, clipping members 3711 may have an engagement slot 3715 and the engagement tip 3714 formed thereon respectively wherein the engagement tip 3714 is adapted to penetrate through the engagement slot 3715 by bending the frame holder 371 to form a close loop thereof for receiving the primary bridge 12. As a result, the engagement tip 3714 is elastic and its diameter is slightly larger than that of the engagement slot 3715 so that the engagement tip 3714 is adapted to be slightly squeezed to pass through the engagement slot 3715 and automatically restore to its original shape so as to interlock with the engagement slot 3715.

Referring to FIG. 10 of the drawings, each of the frame holders 371 may be embodied as elongated in shape having a plurality of engaging tips 3714 formed thereon.

Referring to FIG. 11 to FIG. 13 of the drawings, the magnetic units 385 is formed on the auxiliary bridge 32 as well as two outer sides of the auxiliary frame body 31.

Referring to FIG. 14 and FIG. 17 of the drawings, the frame holder 37 is embodied as having an ‘I’ cross section for supporting on the nose supports 13.

Referring to FIG. 15 to FIG. 16 of the drawings, the magnetic adapters are provided on the primary spectacles frame 1 at its side extensions 15, 16 and the primary bridge 12, whereas the supporting arms 38 are extended from the auxiliary frame body 31 at the corresponding positions to magnetically attach with the magnetic adapters 37.

Referring to FIG. 18 of the drawings, the primary spectacles frame 1 has two side extensions 15, 16, wherein the frame holders 37 are riding on the side extensions 15,16 for magnetically attaching with the magnetic units 385 respectively.

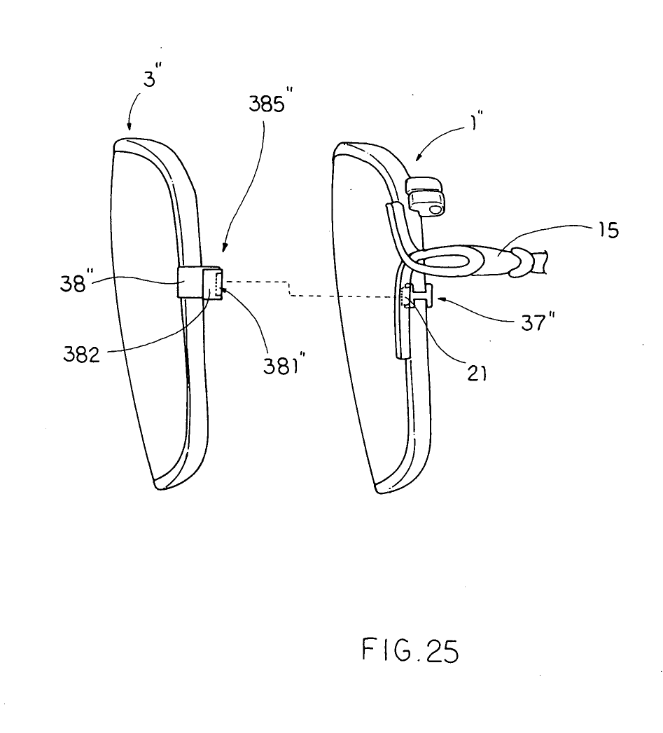

Referring to FIG. 25 of the drawings, a second alternative mode of the spectacles set according to the preferred embodiment of the present invention is illustrated. The second alternative mode is similar to the preferred embodiment except the magnetic adapter and the magnetic unit 385″. According to the second alternative mode, the magnetic adapter comprises two magnetic holders 37″ detachably mounted at the primary spectacles frame 1″ to align with the magnetic members 381″ respectively, such that when the magnetic members 381″ are magnetically attracted with the magnetic holders 37″ respectively, the magnetic auxiliary frame 3″ is detachably mounted on the primary spectacles frame 1″.

As shown in FIG. 25 of the drawings, the magnetic holders 37″ are attached at two outer sides of the primary spectacles frame 1″ wherein the supporting arms 38″ and the magnetic casing 382″ are rearwardly extended from the magnetic auxiliary frame 3″ at the corresponding position for aligning with the magnetic holders 37″ respectively.

It is worth mentioning that the magnetic mounting arrangement is made aesthetically compatible with the primary spectacles frame 1″ and the magnetic auxiliary frame 3″ so as to optimal the application of the present invention.

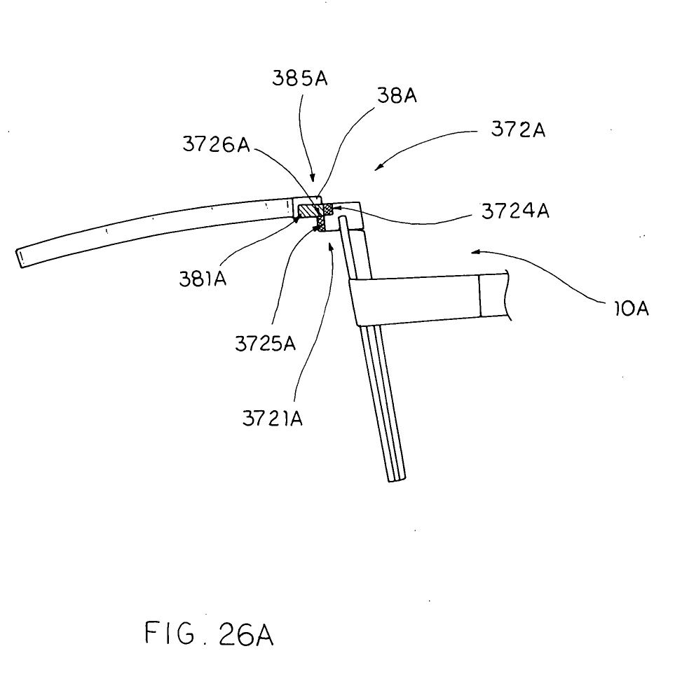

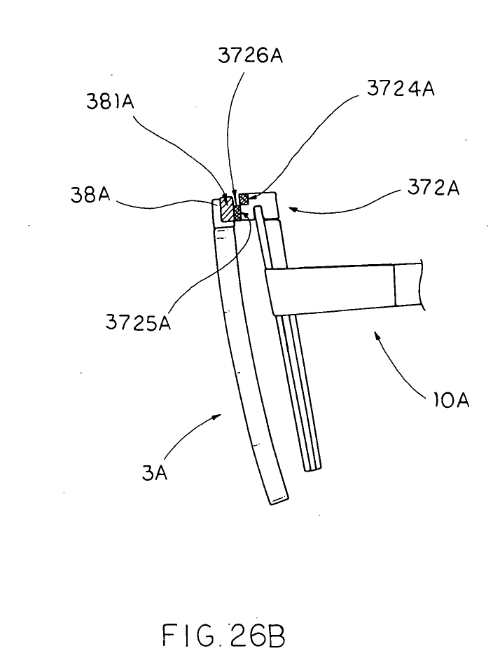

Referring to FIG. 26A and FIG. 26B of the drawings, a third alternative mode of the spectacles set according to the preferred embodiment of the present invention is illustrated. The third alternative mode is similar to the preferred embodiment except the magnetic adapter and the magnetic unit 385A. According to the third alternative mode, each of the magnetic seats 372A has a first and a second attaching surfaces 3724A, 3725A formed as two outer surfaces of the magnetic housing 3721A respectively, wherein the first and second attaching surfaces 3724A, 3725A are not aligned with each other to form a supporting shoulder 3726A between the first and the second attaching surfaces 3724A, 3725A. Moreover, each of the magnetic seats 372A further comprise a third magnetic element wherein the two magnetic elements for each of the magnetic seats 372A are attached on the first and the second attaching surfaces 3724A, 3725A for magnetically attaching with the corresponding magnet unit 385.

More specifically, the supporting arms 38A are adapted to magnetically attach on one of the first and the third magnetic elements at two predetermined directions so as to allow flipping of the magnetic auxiliary frame 3A. For example, when the magnetic auxiliary frame 3A is flipped outwardly with respect to the primary spectacles 10A, the corresponding magnetic member 381A is adapted to magnetically attached with the corresponding first magnetic element supported on the first attaching surface 3724A at a transverse orientation with respective to the primary spectacles 10A so as to allow flipping up of the magnetic auxiliary frame 3A, as shown in FIG. 26A of the drawings. On the other hand, when the magnetic auxiliary frame 3A is downwardly flipped, each of the magnetic members 381A is adapted to magnetically attached with the corresponding third magnetic element supported on the second attaching surface 3725A at an orientation aligning with the primary spectacles 10A so as to allow flipping down of the magnetic auxiliary frame 3A for shielding sunlight, as show in FIG. 26B of the drawings.

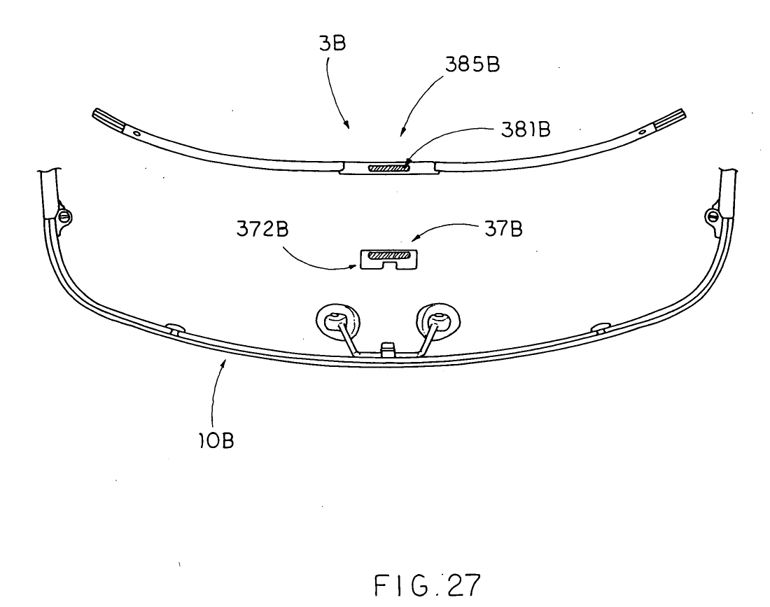

Referring to FIG. 27 of the drawings, a fourth alternative mode of the spectacles set according to the preferred embodiment of the present invention is illustrated. The fourth alternative mode is similar to the preferred embodiment except the primary spectacles 10B and the magnetic auxiliary frame 3B. According to the fourth alternative mode, the primary spectacles 10B is embodied as a sunglasses while the auxiliary lenses 35 of the magnetic auxiliary frame 3B is utilized to provide shortsightedness or long-sightedness adjustment.

Similar to the preferred embodiment, the magnetic adapter is selectively and detachably mounted at the primary spectacles frame 10B to align with the magnetic unit 385B, wherein the magnetic unit 385B is magnetically attracted with the magnetic adapter to detachably mount the magnetic auxiliary frame 3B on the primary spectacles frame 10B.

More specifically, the supporting arm 38B of the magnetic unit 385B is frontwardly extended from the magnetic auxiliary frame 3B to align with the magnetic holder 37B, wherein the magnetic member 381B is downwardly extended from a rear end of the supporting arm 38B so as to magnetically mount on the magnetic holder 37B.

As shown in FIG. 27 of the drawings, the magnetic element is attached on top of the magnetic seat 372B while the magnetic member 381B of the magnetic unit 385B is extended from the magnetic auxiliary frame 3B to magnetically attach on top of the corresponding magnetic seat 372B of the magnetic adapter.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A spectacles set, comprising:
a primary spectacles comprising two lenses and a primary spectacles frame for holding said lenses in position, wherein said primary spectacles frame comprises a primary bridge extended between two inner sides of said lenses respectively and two side extensions extended from two outer sides of said lenses respectively; and
a magnetic auxiliary frame, which comprises:
two auxiliary lenses;
an auxiliary frame body for holding said auxiliary lenses in position, wherein said magnetic auxiliary frame comprises an auxiliary bridge extended between two inner sides of said two auxiliary lenses respectively; and
a magnetic mounting arrangement which comprises:
a magnetic unit extended from said auxiliary frame; and
a magnetic adapter selectively and detachably mounted at said primary spectacles frame to align with said magnetic unit, wherein said magnetic unit is magnetically attracted with said magnetic adapter to detachably mount said magnetic auxiliary frame on said primary spectacles frame.

2. The spectacles set, as recited in claim 1, wherein said magnetic unit comprises at least one magnetic member extended from said magnetic auxiliary frame, wherein said magnetic adapter comprises at least one magnetic holder detachably mounted at said primary spectacles frame to align with said magnetic member, such that when said magnetic member is magnetically attracted with said magnetic holder, said magnetic auxiliary frame is detachably mounted on said primary spectacles frame.

3. The spectacles set, as recited in claim 2, wherein said magnetic holder comprises a frame holder detachably mounted to said primary spectacles frame and a magnetic seat which comprises a magnetic housing supported by said frame holder and a first magnetic element received in said magnetic housing, wherein said magnetic member is magnetically mounted to said first magnetic element to retain said magnetic auxiliary frame on said primary spectacles frame.

4. The spectacles set, as recited in claim 3, wherein said magnetic member comprises a magnetic casing and a second magnetic element received in said magnetic casing to form an engaging groove within said magnetic casing, wherein a thickness of said first magnetic element is larger than a depth of said magnetic housing to form an engaging member arranged in such a manner that when said magnetic member is magnetically mounted on said magnetic seat, said engaging member is received in said engaging groove so as to ensure said magnetic auxiliary frame mounting on said primary spectacles frame.

5. The spectacles set, as recited in claim 3, wherein said frame holder is a clipping member detachably clipping at said nose support of said primary spectacles frame to support said magnetic seat so as to magnetically attract said magnetic member.

6. The spectacles set, as recited in claim 4, wherein said frame holder is a clipping member detachably clipping at said nose support of said primary spectacles frame to support said magnetic seats so as to magnetically attract said magnetic members respectively.

7. The spectacles set, as recited in claim 5, wherein said magnetic unit further comprises a supporting arm extended from said magnetic auxiliary frame to align with said magnetic holder, wherein said magnetic member is downwardly extended from a rear end of said supporting arm to magnetically mount on said magnetic holder.

8. The spectacles set, as recited in claim 6, wherein said magnetic unit further comprises a supporting arm extended from said magnetic auxiliary frame to align with said magnetic holder, wherein said magnetic member is downwardly extended from a rear end of said supporting arm to magnetically mount on said magnetic holder.

9. The spectacles set, as recited in claim 7, wherein said supporting arm is rearwardly extended from said auxiliary bridge to ride across said primary bridge so as to magnetically mount to said magnetic holder.

10. The spectacles set, as recited in claim 8, wherein said supporting arm is rearwardly extended from said auxiliary bridge to ride across said primary bridge so as to magnetically mount to said magnetic holder.

11. The spectacles set, as recited in claim 3, wherein said frame holder has a retention slot formed at a rear side of one of said side extensions of said primary spectacles frame and comprises an inserting member which supports said respective magnetic seat thereon and detachably inserts into said retention slot to magnetically attract said respective magnetic member.

12. The spectacles set, as recited in claim 4, wherein said frame holder has a retention slot formed at a rear side of one of said side extensions of said primary spectacles frame and comprises an inserting member which supports said respective magnetic seat thereon and detachably inserts into said retention slot to magnetically attract said respective magnetic member.

13. The spectacles set, as recited in claim 11, wherein said magnetic unit further comprises a supporting arm extended from said magnetic auxiliary frame to align with said magnetic holder, wherein said magnetic member is downwardly extended from a rear end of said supporting arm to magnetically mount on said magnetic holder.

14. The spectacles set, as recited in claim 12, wherein said magnetic unit further comprises a supporting arm extended from said magnetic auxiliary frame to align with said magnetic holder, wherein said magnetic member is downwardly extended from a rear end of said supporting arm to magnetically mount on said magnetic holder.

15. The spectacles set, as recited in claim 13, wherein said supporting arm is rearwardly and spacedly extended from an outer side of one of said auxiliary lens of said auxiliary bridge to ride across said corresponding side extension so as to magnetically mount to said magnetic holder.

16. The spectacles set, as recited in claim 14, wherein said supporting arm is rearwardly and spacedly extended from an outer side of one of said auxiliary lens of said auxiliary bridge to ride across said corresponding side extension so as to magnetically mount to said magnetic holder.

17. The spectacles set, as recited in claim 1, wherein said magnetic adapter is detachably mounted at said primary spectacles frame at a position between said two inner sides of said lenses, wherein said magnetic unit is rearwardly extended from said auxiliary frame body to alignedly and magnetically attract to said magnetic adapter so as to detachably mount said magnetic auxiliary frame in front of said primary spectacles frame.

18. The spectacles set, as recited in claim 17, wherein said magnetic adapter is detachably mounted at said primary bridge of said primary spectacles frame, wherein said magnetic unit is rearwardly extended from said auxiliary frame body to ride across said primary bridge to alignedly and magnetically attract to said magnetic adapter so as to detachably mount said magnetic auxiliary frame in front of said primary spectacles frame.

19. The spectacles set, as recited in claim 3, wherein said magnetic unit further comprises a supporting arm extended from said magnetic auxiliary frame to align with said magnetic holder, wherein said magnetic member is downwardly extended from a rear end of said supporting arm to magnetically mount on said magnetic holder.

20. The spectacles set, as recited in claim 19, wherein said magnetic seat has a first attaching surface mounting with said first magnetic element, and a second attaching surface protruded from a bottom edge of said first attaching surface, wherein said magnetic seat further comprises an auxiliary magnetic element mounting on said second attaching surface, in such a manner that said when said magnetic auxiliary frame is flipped away from said primary spectacles, said supporting arm is arranged to transversely extend to magnetically attach said magnetic member on said first magnetic element on said first attaching surface, and when said magnetic auxiliary frame is flipped to overlap said primary spectacles, said supporting arm is arranged to extend to magnetically attach said magnetic member on said auxiliary magnetic element on said second attaching surface.

21. The spectacles set, as recited in claim 20, wherein said magnetic member comprises a magnetic casing and a second magnetic element received in said magnetic casing to form an engaging groove within said magnetic casing, wherein a thickness of said first magnetic element is larger than a depth of said magnetic housing to form an engaging member arranged in such a manner that when said magnetic member is magnetically mounted on said magnetic seat, said engaging member is received in said engaging groove so as to ensure said magnetic auxiliary frame mounting on said primary spectacles frame.

22. The spectacles set, as recited in claim 21, wherein said frame holder is a clipping member detachably clipping at said nose support of said primary spectacles frame to support said magnetic seat so as to magnetically attract said magnetic member.

23. A magnetic auxiliary frame for detachably mounting on a primary spectacles which comprises a primary spectacles frame for holding two lenses in portion, wherein said magnetic auxiliary frame comprises:
two auxiliary lenses;
an auxiliary frame body for holding said auxiliary lenses in position, wherein said auxiliary frame body comprises an auxiliary bridge extended between two inner sides of said two auxiliary lenses respectively; and
a magnetic mounting arrangement which comprises:
a magnetic unit extended from said auxiliary frame body; and
a magnetic adapter adapted for detachably mounting at said primary spectacles frame to align with said magnetic unit, wherein said magnetic unit is magnetically attracted with said magnetic adapter for detachably mounting said magnetic auxiliary frame on said primary spectacles frame.

24. The magnetic auxiliary frame, as recited in claim 23, wherein said magnetic unit comprises two magnetic members spacedly extended from said auxiliary frame body, wherein said magnetic adapter comprises two magnetic holders adapted for detachably and spacedly mounting said primary spectacles frame to align with said two magnetic members respectively, such that said magnetic holders are magnetically attracted with said magnetic holders respectively for detachably mounting said magnetic auxiliary frame on said primary spectacles frame.

25. The magnetic auxiliary frame, as recited in claim 24, wherein each of said magnetic holders comprises a frame holder adapted for detachably mounting to said primary spectacles frame and a magnetic seat which comprises a magnetic housing supported by said frame holder and a first magnetic element received in said magnetic housing, wherein said magnetic members are magnetically mounted to said first magnetic elements respectively for retaining said magnetic auxiliary frame on said primary spectacles frame.

26. The magnetic auxiliary frame, as recited in claim 25, wherein each of said magnetic members comprises a magnetic casing and a second magnetic element received in said magnetic casing to form an engaging groove within said magnetic casing, wherein a thickness of said first magnetic element is larger than a depth of said magnetic housing to form an engaging member arranged in such a manner that when said magnetic members are magnetically mounted on said magnetic seats respectively, said engaging members are received in said engaging grooves respectively so as to ensure said magnetic auxiliary frame mounting on said primary spectacles frame.

27. The magnetic auxiliary frame, as recited in claim 25, wherein said frame holder is two clipping members adapted for detachably clipping on said nose supports of said primary spectacles frame to support said magnetic seats so as to magnetically attract said magnetic holders respectively.

28. The magnetic auxiliary frame, as recited in claim 26, said frame holder is two clipping members adapted for detachably clipping on said nose supports of said primary spectacles frame to support said magnetic seats so as to magnetically attract said magnetic holders respectively.

29. The magnetic auxiliary frame, as recited in claim 27, wherein said magnetic unit further comprises a plurality of supporting arms extended from said auxiliary frame body to align with said magnetic holders respectively, wherein said two magnetic members are downwardly extended from rear ends of said supporting arms to magnetically mount on said magnetic holders respectively.

30. The magnetic auxiliary frame, as recited in claim 28, wherein said magnetic unit further comprises two supporting arms rearwardly extended from said auxiliary frame body to align with said magnetic holders respectively, wherein said two magnetic members are downwardly extended from rear ends of said supporting arms to magnetically mount on said magnetic holders respectively.

31. The magnetic auxiliary frame, as recited in claim 29, wherein said two supporting arms are rearwardly and spacedly extended from said auxiliary bridge for riding across said primary bridge so as to magnetically mount to said magnetic holders respectively.

32. The magnetic auxiliary frame, as recited in claim 30, wherein said two supporting arms are rearwardly and spacedly extended from said auxiliary bridge for riding across said primary bridge so as to magnetically mount to said magnetic holders respectively.

33. The magnetic auxiliary frame, as recited in claim 23, wherein said magnetic adapter is adapted for detachably mounting at said primary spectacles frame at a position between two inner sides of said lenses, wherein said magnetic unit is rearwardly extended from said auxiliary frame body to alignedly and magnetically attract to said magnetic adapter for detachably mounting said magnetic auxiliary frame in front of said primary spectacles frame.

34. The magnetic auxiliary frame, as recited in claim 33, wherein said magnetic adapter is adapted for detachably mounting at a primary bridge of said primary spectacles frame, wherein said magnetic unit is rearwardly extended from said auxiliary frame body for riding across said primary bridge to alignedly and magnetically attract to said magnetic adapter so as to detachably mount said magnetic auxiliary frame in front of said primary spectacles frame.

35. The magnetic auxiliary frame, as recited in claim 3, wherein said magnetic unit further comprises a supporting arm extended from said magnetic auxiliary frame to align with said magnetic holder, wherein said magnetic member is downwardly extended from a rear end of said supporting arm to magnetically mount on said magnetic holder.

36. The magnetic auxiliary frame, as recited in claim 25, wherein said magnetic seat has a first attaching surface mounting with said first magnetic element, and a second attaching surface protruded from a bottom edge of said first attaching surface, wherein said magnetic seat further comprises an auxiliary magnetic element mounting on said second attaching surface, in such a manner that said when said magnetic auxiliary frame is flipped away from said primary spectacles, said supporting arm is arranged to transversely extend to magnetically attach said magnetic member on said first magnetic element on said first attaching surface, and when said magnetic auxiliary frame is flipped to overlap said primary spectacles, said supporting arm is arranged to extend to magnetically attach said magnetic member on said auxiliary magnetic element on said second attaching surface.

37. The magnetic auxiliary frame, as recited in claim 36, wherein said magnetic member comprises a magnetic casing and a second magnetic element received in said magnetic casing to form an engaging groove within said magnetic casing, wherein a thickness of said first magnetic element is larger than a depth of said magnetic housing to form an engaging member arranged in such a manner that when said magnetic member is magnetically mounted on said magnetic seat, said engaging member is received in said engaging groove so as to ensure said magnetic auxiliary frame mounting on said primary spectacles frame.

38. The magnetic auxiliary frame, as recited in claim 37, wherein said frame holder is a clipping member detachably clipping at said nose support of said primary spectacles frame to support said magnetic seat so as to magnetically attract said magnetic member.
